(19) United States
(12) Patent Application Publication
(10) Pub. No.: US 2022/0178716 A1
(43) Pub. Date: Jun. 9, 2022

(54) ELECTRONIC DEVICE FOR VEHICLES AND OPERATION METHOD THEREOF

(71) Applicant: LG Electronics Inc., Seoul (KR)

(72) Inventor: Hansung LEE, Seoul (KR)

(21) Appl. No.: 17/259,259

(22) PCT Filed: Aug. 23, 2019
(86) PCT No.: PCT/KR2019/010735

§ 371 Date: Jan. 11, 2021

(51) Int. Cl. G01C 21/00

(52) U.S. Cl. CPC G01C 21/3815; B60W 60/001

(57) ABSTRACT

Disclosed are an electronic device for vehicles, the electronic device including an interface and a processor configured to acquire an existing map through the interface, to acquire a newly generated feature through the interface, to input the feature to an artificial neural network pre-trained through machine learning in order to generate a new map feature, to generate a new cell based on the new map feature upon determining that an existing map feature included in a cell of the existing map discords with the new map feature, and to replace the cell in which discordance occurs with the new cell when a vehicle enters the cell in which discordance occurs, and an operation method thereof. Data generated by the electronic device for vehicles may be transmitted to an external device using a 5G communication scheme. An electronic device of an autonomous vehicle may be connected or converged with an artificial intelligence module, an unmanned aerial vehicle (UAV), a robot, an augmented reality (AR) apparatus, a virtual reality (VR) apparatus, an apparatus related to a 5G service, etc.

### TECHNICAL FIELD

The present disclosure relates to an electronic device for vehicles and an operation method thereof. More particularly, the present disclosure relates to an electronic device for vehicles and an operation method thereof that are capable of generating and storing a new map linkable to an existing map such that the new map is loaded when a vehicle enters the point corresponding to the map even in the case in which existing map information is absent or incorrect.

### BACKGROUND ART

A vehicle is an apparatus that moves a passenger in a direction in which the passenger wishes to go. A representative example of the vehicle is a car. An autonomous vehicle means a vehicle capable of automatically traveling without human manipulation.

A vehicle may be loaded with map information that guides a traveling route of the vehicle. Particularly, for an autonomous vehicle, it is necessary for the loaded map information to correctly reflect reality such that autonomous traveling is smoothly performed. However, updating the map information loaded in the vehicle in real time is technically limited. Therefore, there is a necessity to develop technology capable of continuously comparing map information and reality information in order to secure traveling safety.

Korean Patent Application Publication No. 10-2018-0103462 discloses a method of accumulating GPS data and lidar sensor data in time sequence and matching the same with map information in order to estimate the current position of a vehicle. However, the Korean patent application publication does not disclose technology for detecting accuracy of the map information, and therefore does not suggest a countermeasure when the map information is different from the reality information.

U.S. Pat. No. 8,903,591 B1 discloses a method of comparing map data with sensor data to detect deficiency of the map data and guiding a traveling route through additional sensor data when the map data are deficient. In the US registered patent, however, only additional sensor data are acquired and used such that autonomous traveling is continued even in the case in which the map data are deficient, but new map data capable of replacing an area having deficient map data are not generated. For this reason, when a vehicle enters the area again, a process of acquiring additional sensor data, which has been previously performed, and a process of setting a traveling route based thereon must be repeated.

### DISCLOSURE

### Technical Problem

It is a first object of the present disclosure to provide an electronic device for vehicles and an operation method thereof that are capable of proving map information guiding a traveling route of a vehicle even in an area in which existing map information is absent or incorrect.

It is a second object of the present disclosure to provide an electronic device for vehicles and operation method thereof that are capable of, when a vehicle enters an area in which existing map information is absent or incorrect and map information has already been generated again, loading the map information that has already been generated in order to efficiently guide a traveling route of a vehicle.

The objects of the present disclosure are not limited to the above-mentioned object, and other objects that have not been mentioned above will become evident to those skilled in the art from the following description.

### Technical Solution

In accordance with an aspect of the present disclosure, the above objects can be accomplished by the provision of an electronic device for vehicles, the electronic device including an interface and a processor configured to acquire an existing map through the interface, to acquire a newly generated feature through the interface, to input the feature to an artificial neural network pre-trained through machine learning in order to generate a new map feature, to generate a new cell based on the new map feature upon determining that an existing map feature included in a cell of the existing map discords with the new map feature, and to replace the cell in which discordance occurs with the new cell when a vehicle enters the cell in which discordance occurs. Consequently, it is possible to provide map information guiding a traveling route of the vehicle even in an area in which existing map information is absent or incorrect.

The processor may generate the new cell so as to include the new map feature and to be compatible with a format of the existing map.

The electronic device may further include a memory, wherein the memory may be configured to receive and store information about the new cell from the processor. In this case, the processor may mark the cell in which discordance occurs with the fact that discordance occurs, and may record an address of the new cell, stored in the memory, in the existing map.

When the vehicle enters the cell in which discordance occurs, the processor may load information about the new cell stored in the memory based on the address of the new cell at the position of the cell in which discordance occurs, whereby it is possible to continuously guide a correct traveling route of the vehicle.

In accordance with another aspect of the present disclosure, there is provided an operation method of an electronic device for vehicles, the operation method including at least one processor acquiring an existing map, the at least one processor acquiring a newly generated feature, the at least one processor inputting the feature to an artificial neural network pre-trained through machine learning in order to generate a new map feature, the at least one processor generating a new cell based on the new map feature upon determining that an existing map feature included in a cell of the existing map discords with the new map feature, and the at least one processor replacing the cell in which discordance occurs with the new cell when a vehicle enters the cell in which discordance occurs.

Other technical solutions unmentioned above may be sufficiently derived from the description of embodiments of the present disclosure.

### Advantageous Effects

According to the present disclosure, one or more of the following effects are provided.

First, when an existing map feature discords with a new map feature, a cell in which discordance occurs is replaced with a new cell, whereby it is possible to provide map information guiding a traveling route of a vehicle even in the case in which existing map information is absent or incorrect.

Second, the new cell is generated so as to be compatible with the format of an existing map, whereby it is possible to secure linkability between the new cell and the existing map.

Third, a cell in which the existing map feature discords with the new map feature is marked with the fact that discordance occurs, and the address of a new cell that replaces the cell in which discordance occurs is recorded in the existing map information, whereby, when the vehicle enters the cell in which discordance occurs, it is possible to easily load the new cell matched therewith.

### DESCRIPTION OF DRAWINGS

FIG. 1 is a view showing the external appearance of a vehicle according to an embodiment of the present disclosure.

FIG. 2 is a control block diagram of the vehicle according to the embodiment of the present disclosure.

FIG. 3 is a control block diagram of an electronic device according to an embodiment of the present disclosure.

FIGS. 4a and 4b show an example of the basic operation and applied operation of an autonomous vehicle and a 5G network in a 5G communication system.

FIG. 5 is a flowchart of a processor according to an embodiment of the present disclosure.

FIG. 6 shows an example in which a map feature according to an embodiment of the present disclosure is generated.

FIG. 7 shows an example of a process of generating a cell from a feature according to an embodiment of the present disclosure.

FIGS. 8 and 9 illustrate an example of the format of an existing map according to an embodiment of the present disclosure.

FIG. 10 is a view showing an embodiment of a replacement step (S700) according to an embodiment of the present disclosure.

FIGS. 11 and 12 show an example of storage and loading of a new cell according to an embodiment of the present disclosure.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve different meanings. Also, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

It will be understood that, although the terms “first,” “second,” etc., may be used herein to describe various components, these components should not be limited by these terms. These terms are only used to distinguish one component from another component.

It will be understood that, when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

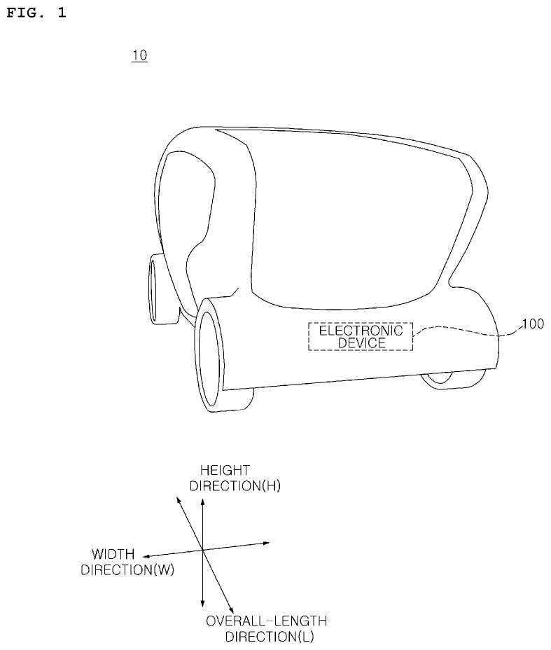

FIG. 1 is a view showing the external appearance of a vehicle according to an embodiment of the present disclosure.

Referring to FIG. 1, the vehicle 10 according to the embodiment of the present disclosure is defined as a transport means that runs on a road or a railway. The vehicle 10 is a concept including a car, a train, and a motorcycle. The vehicle 10 may be a concept including all of an internal combustion engine vehicle including an engine as a power source, a hybrid vehicle including both an engine and an electric motor as a power source, and an electric vehicle including an electric motor as a power source. The vehicle 10 may be a shared vehicle. The vehicle 10 may be an autonomous vehicle.

The vehicle 10 may include an electronic device 100. The electronic device 100 may be a device that acquires a map indicating a route along which the vehicle 100 travels, determines whether the map accords with information about reality in which the vehicle 10 travels, and determines whether to continuously use the map or to use a new map that replaces the map. The vehicle 10 may set a route along which the vehicle travels based on the map determined by the electronic device 100.

Meanwhile, the vehicle 10 may interact with at least one robot. The robot may be an autonomous mobile robot (AMR). The mobile robot may move autonomously and thus may move freely. The mobile robot may be provided with a plurality of sensors for avoiding obstacles during traveling, whereby the mobile robot may travel while avoiding obstacles. The mobile robot may be a flying robot including a flight device (e.g. a drone). The mobile robot may be a wheeled robot that includes at least one wheel and moves through rotation of the wheel. The mobile robot may be a leg type robot that includes at least one leg and moves using the leg.

The robot may function as a device that supplements the convenience of a user of the vehicle 10. For example, the robot may perform a function of moving cargo loaded in the vehicle 10 to a final destination of the user. For example, the robot may perform a function of guiding the user that exits the vehicle 10 to the final destination. For example, the robot may perform a function of transporting the user that exits the vehicle 10 to the final destination.

At least one electronic device included in the vehicle may communicate with the robot through a communication device 220.

The at least one electronic device included in the vehicle may provide data processed by the at least one electronic device included in the vehicle to the robot. For example, the at least one electronic device included in the vehicle may provide at least one of object data, HD map data, vehicle state data, vehicle position data, or driving plan data to the robot.

The at least one electronic device included in the vehicle may receive data processed by the robot from the robot. The at least one electronic device included in the vehicle may receive at least one of sensing data, object data, robot state data, robot position data, or robot moving plan data generated by the robot.

The at least one electronic device included in the vehicle may generate a control signal based further on data received from the robot. For example, the at least one electronic device included in the vehicle may compare information about an object generated by an object detection device 210 and information about an object generated by the robot with each other, and may generate a control signal based on the result of comparison.

The at least one electronic device included in the vehicle may generate a control signal such that interference between the movement route of the vehicle 100 and the movement route of the robot does not occur.

The at least one electronic device included in the vehicle may include a software or hardware module that realizes artificial intelligence (AI) (hereinafter referred to as an artificial intelligence module).

The at least one electronic device included in the vehicle may input acquired data to the artificial intelligence module, and use data output from the artificial intelligence module.

The artificial intelligence module may perform machine learning with respect to input data using at least one artificial neural network (ANN). The artificial intelligence module may output driving plan data through machine learning with respect to input data.

The at least one electronic device included in the vehicle may generate a control signal based on data output from the artificial intelligence module.

In some embodiments, the at least one electronic device included in the vehicle may receive data processed by artificial intelligence from an external device through the communication device 220. The at least one electronic device included in the vehicle may generate a control signal based on data processed by artificial intelligence.

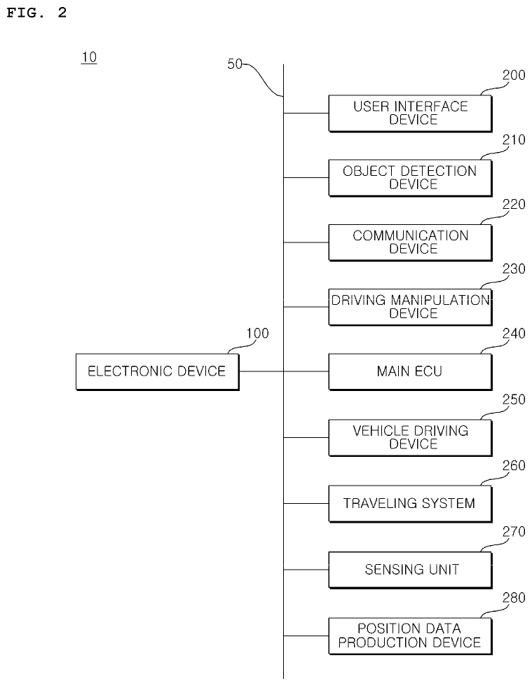

FIG. 2 is a control block diagram of the vehicle according to the embodiment of the present disclosure.

Referring to FIG. 2, the vehicle 10 may include an electronic device 100 for vehicles, a user interface device 200, an object detection device 210, a communication device 220, a driving manipulation device 230, a main ECU 240, a vehicle driving device 250, a traveling system 260, a sensing unit 270, and a position data production device 280.

The electronic device 100 may detect an object through the object detection device 210. The electronic device 100 may exchange data with an adjacent vehicle using the communication device 220. The electronic device 100 may control the movement of the vehicle 10, or may generate a signal for outputting information to the user, based on data about object received using the traveling system 260. In this case, a microphone, a speaker, and a display provided in the vehicle 10 may be used. The electronic device 100 may safely control traveling through the vehicle driving device 250.

The user interface device 200 is a device for communication between the vehicle 10 and the user. The user interface device 200 may receive user input, and may provide information generated by the vehicle 10 to the user. The vehicle 100 may realize a user interface (UI) or a user experience (UX) through the user interface device 200.

The user interface device 200 may include an input unit and an output unit.

The input unit is configured to receive information from the user. Data collected by the input unit may be processed as a control command of the user. The input unit may include a voice input unit, a gesture input unit, a touch input unit, and a mechanical input unit. The output unit is configured to generate output related to visual sensation, aural sensation, or tactile sensation, and may include at least one of a display unit, a sound output unit, or a haptic output unit.

The display unit may display a graphical object corresponding to various kinds of information. The display unit may include at least one of a liquid crystal display (LCD), a thin film transistor-liquid crystal display (TFT LCD), an organic light-emitting diode (OLED), a flexible display, a 3D display, or an e-ink display.

The display unit 251 may be connected to the touch input unit in a layered structure, or may be formed integrally with the touch input unit, so as to realize a touchscreen. The display unit may be realized as a head-up display (HUD). In this case, the display unit may include a projection module in order to output information through an image projected onto a windshield or a window. The display unit may include a transparent display. The transparent display may be attached to the windshield or the window.

The display unit may be realized in a portion of a steering wheel, portions of an instrument panel, a portion of a seat, a portion of each pillar, a portion of a door, a portion of a center console, a portion of a head lining, a portion of a sun visor, a portion of the windshield, or a portion of the window.

Meanwhile, the user interface device 200 may include a plurality of display units.

The sound output unit converts an electrical signal provided from a processor 170 into an audio signal, and outputs the converted audio signal. To this end, the sound output unit may include one or more speakers.

The haptic output unit generates tactile output. For example, the haptic output unit may vibrate the steering wheel, a safety belt, and the seat such that the user recognizes the output.

Meanwhile, the user interface device 200 may be referred to as a display device for vehicles.

The object detection device 210 may include at least one sensor for detecting an object outside the vehicle 10. The object detection device 210 may include at least one of a camera, a radar, a lidar, an ultrasonic sensor, an infrared sensor, or a processor. The object detection device 210 may provide data about an object generated based on a sensing signal generated by the sensor to the at least one electronic device included in the vehicle.

The object may be various bodies related to the operation of the vehicle 10. For example, the object may include a lane, another vehicle, a pedestrian, a two-wheeled vehicle, a traffic signal, light, a road, a structure, a speed bump, a geographical body, and an animal.

Meanwhile, the object may be classified as a moving object or a stationary object. For example, the moving object may be a concept including another vehicle and a pedestrian, and the stationary object may be a concept including a traffic signal, a road, and a structure.

The camera may generate information about an object outside the vehicle 10 using an image. The camera may include at least one lens, at least one image sensor, and at least one processor electrically connected to the image sensor for processing a signal that is received and generating data about the object based on the processed signal.

The camera may be at least one of a mono camera, a stereo camera, or an around view monitoring (AVM) camera. The camera may acquire information about the position of the object, information about the distance from the object, or information about speed relative to the object using various image processing algorithms. For example, the camera may acquire the distance information from the object and the speed information relative to the object based on a change in the size of the object over time in an acquired image.

For example, the camera may acquire the distance information from the object and the speed information relative to the object through a pin hole model or road surface profiling.

For example, the camera may be disposed in the vehicle so as to be adjacent to a front windshield in order to acquire an image ahead of the vehicle. Alternatively, the camera 310 may be disposed around a front bumper or a radiator grill.

For example, the camera may acquire the distance information from the object and the speed information relative to the object from a stereo image acquired by the stereo camera based on disparity information.

The radar may generate information about an object outside the vehicle 10 using an electric wave.

The radar may include an electromagnetic wave transmission unit, an electromagnetic wave reception unit, and at least one processor electrically connected to the electromagnetic wave transmission unit and the electromagnetic wave reception unit for processing a signal that is received and generating data about the object based on the processed signal.

The radar may be realized using a pulse radar scheme or a continuous wave radar scheme based on an electric wave emission principle. In the continuous wave radar scheme, the radar may be realized using a frequency modulated continuous wave (FMCW) scheme or a frequency shift keying (FSK) scheme based on a signal waveform. The radar may detect an object based on a time of flight (TOF) scheme or a phase-shift scheme through the medium of an electromagnetic wave, and may detect the position of the detected object, the distance from the detected object, and the speed relative to the detected object.

The lidar may generate information about an object outside the vehicle 10 using laser light. The lidar may include an optical transmission unit, an optical reception unit, and at least one processor electrically connected to the optical transmission unit and optical reception unit for processing a signal that is received and generating data about the object based on the processed signal.

The lidar may be realized using a time of flight (TOF) scheme or a phase-shift scheme. The lidar may be of a driving type or a non-driving type. The driving type lidar may be rotated by a motor in order to detect an object around the vehicle 10. The non-driving type lidar may detect an object located within a predetermined range from the vehicle through light steering.

The vehicle 10 may include a plurality of non-driving type lidars. The lidar may detect an object based on a time of flight (TOF) scheme or a phase-shift scheme through the medium of laser light, and may detect the position of the detected object, the distance from the detected object, and the speed relative to the detected object.

The communication device 220 may exchange a signal with a device located outside the vehicle 10. The communication device 220 may exchange a signal with at least one of infrastructure (e.g. a server or a broadcasting station) or another vehicle. The communication device 220 may include at least one of a transmission antenna, a reception antenna, a radio frequency (RF) circuit capable of realizing various communication protocols, or an RF element in order to perform communication.

The communication device 220 may include a short range communication unit, a position information unit, a V2X communication unit, an optical communication unit, a broadcast transmission and reception unit, and an intelligent transport system (ITS) communication unit.

The V2X communication unit is a unit for wireless communication with a server (V2I: Vehicle to Infrastructure), another vehicle (V2V: Vehicle to Vehicle), or a pedestrian (V2P: Vehicle to Pedestrian). The V2X communication unit may include an RF circuit capable of realizing protocols for communication with infrastructure (V2I), communication between vehicles (V2V), and communication with a pedestrian (V2P).

Meanwhile, the communication device 220 may realize a display device for vehicles together with the user interface device 200. In this case, the display device for vehicles may be referred to as a telematics device or an audio video navigation (AVN) device.

The communication device 220 may communicate with a device located outside the vehicle 10 using a 5G (e.g. new radio (NR)) communication system. The communication device 220 may realize V2X (V2V, V2D, V2P, or V2N) communication using a 5G scheme.

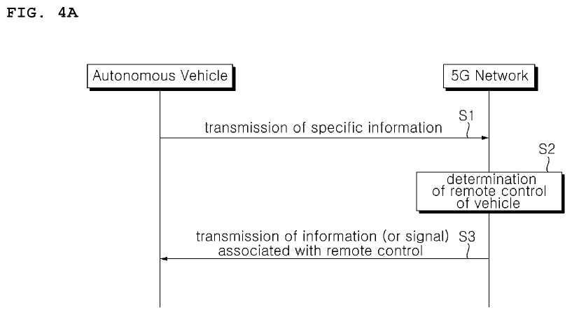

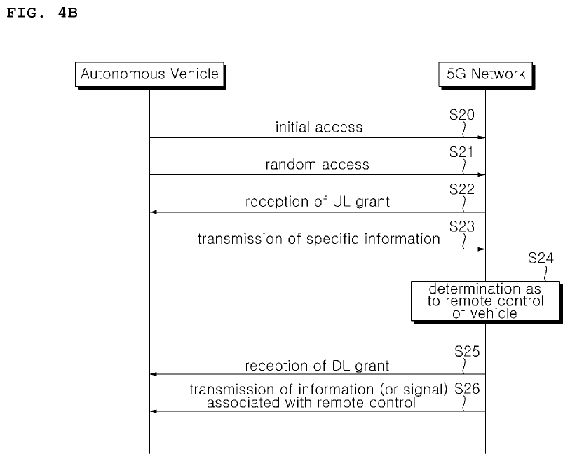

FIGS. 4a and 4b show an example of the basic operation and applied operation of an autonomous vehicle and a 5G network in the 5G communication system.

FIG. 4a shows an example of the basic operation of the autonomous vehicle and the 5G network in the 5G communication system.

The autonomous vehicle transmits specific information to the 5G network (S1).

The specific information may include information related to autonomous traveling.

The information related to autonomous traveling may be information that is directly related to control of traveling of the vehicle. For example, the information related to autonomous traveling may include one or more of object data indicating an object around the vehicle, map data, vehicle state data, vehicle position data, and driving plan data.

The information related to autonomous traveling may further include service information necessary for autonomous traveling. For example, the specific information may include information about a destination and safety class of the vehicle input through a user terminal. The 5G network may determine whether to remotely control the vehicle (S2).

Here, the 5G network may include a server or module for performing remote control related to autonomous traveling.

The 5G network may transmit information (or a signal) related to remote control to the autonomous vehicle (S3).

As described above, the information related to remote control may be a signal that is directly applied to the autonomous vehicle, and may further include service information necessary for autonomous traveling. In an embodiment of the present disclosure, the autonomous vehicle may receive service information, such as information about insurance by section and a danger section selected on the traveling route, through a server connected to the 5G network in order to provide a service related to autonomous traveling.

FIG. 4b shows an example of the applied operation of the autonomous vehicle and the 5G network in the 5G communication system.

The autonomous vehicle performs initial access to the 5G network (S20).

The initial access includes a cell search process for acquiring a downlink (DL) operation and a process of acquiring system information.

The autonomous vehicle performs random access to the 5G network (S21).

The random access includes a process of transmitting a preamble for acquiring uplink (UL) synchronization or UL data transmission and a process of receiving a response to the random access, which will be described in more detail in paragraph G.

The 5G network transmits UL grant for scheduling the transmission of specific information to the autonomous vehicle (S22).

Reception of the UL grant includes a process of receiving time/frequency resource scheduling for transmission of UL data to the 5G network.

The autonomous vehicle transmits specific information to the 5G network based on the UL grant (S23).

The 5G network determines whether to remotely control the vehicle (S24).

The autonomous vehicle receives DL grant through a physical downlink control channel in order to receive a response to the specific information from the 5G network (S25).

The 5G network transmits information (or a signal) related to remote control to the autonomous vehicle based on the DL grant (S26).

The driving manipulation device 230 is a device that receives user input for driving. In a manual mode, the vehicle 10 may be operated based on a signal provided by the driving manipulation device 230. The driving manipulation device 230 may include a steering input device (e.g. a steering wheel), an acceleration input device (e.g. an accelerator pedal), and a brake input device (e.g. a brake pedal).

The main ECU 240 may control the overall operation of the at least one electronic device included in the vehicle.

The vehicle driving device 250 is a device that electrically controls various driving devices in the vehicle 10. The vehicle driving device 250 may include a powertrain driving control device, a chassis driving control device, a door/window driving control device, a safety apparatus driving control device, a lamp driving control device, and an air conditioner driving control device.

The powertrain driving control device may include a power source driving control device and a gearbox driving control device. The chassis driving control device may include a steering driving control device, a brake driving control device, and a suspension driving control device.

Meanwhile, the safety apparatus driving control device may include a safety belt driving control device for controlling a safety belt.

The vehicle driving device 250 may be referred to as an electronic control unit (ECU).

The traveling system 260 may control the movement of the vehicle 10, or may generate a signal for outputting information to the user, based on data about an object received by the object detection device 210. The traveling system 260 may provide the generated signal to at least one of the user interface device 200, the main ECU 240, or the vehicle driving device 250.

The traveling system 260 may be a concept including an ADAS. The ADAS 260 may realize at least one of an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, a high beam assist (HBA) system, an auto parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous traveling route based on data received from at least one of other electronic devices in the vehicle 10. The autonomous ECU may set the autonomous traveling route based on data received from at least one of the user interface device 200, the object detection device 210, the communication device 220, the sensing unit 270, or the position data production device 280. The autonomous ECU may generate a control signal such that the vehicle 10 travels along the autonomous traveling route. The control signal generated by the autonomous ECU may be provided to at least one of the main ECU 240 or the vehicle driving device 250.

The sensing unit 270 may sense the state of the vehicle. The sensing unit 270 may include at least one of an inertial navigation unit (INU) sensor, a collision sensor, a wheel sensor, a speed sensor, a slope sensor, a weight sensor, a heading sensor, a position module, a vehicle forward/rearward movement sensor, a battery sensor, a fuel sensor, a tire sensor, a steering wheel rotation sensor, an in-vehicle temperature sensor, an in-vehicle humidity sensor, an ultrasonic sensor, an ambient light sensor, an accelerator pedal position sensor, and a brake pedal position sensor. Meanwhile, the INU sensor may include one or more of an acceleration sensor, a gyro sensor, and a magnetic sensor.

The sensing unit 270 may generate vehicle state data based on a signal generated by at least one sensor. The sensing unit 270 may acquire vehicle orientation information, vehicle motion information, vehicle yaw information, vehicle roll information, vehicle pitch information, vehicle collision information, vehicle direction information, vehicle angle information, vehicle speed information, vehicle acceleration information, vehicle tilt information, vehicle forward/rearward movement information, battery information, fuel information, tire information, vehicle lamp information, in-vehicle temperature information, in-vehicle humidity information, and a sensing signal, such as a steering wheel rotation angle, ambient light outside the vehicle, pressure applied to an accelerator pedal, and pressure applied to a brake pedal.

In addition, the sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, and a crank angle sensor (CAS).

The sensing unit 270 may generate vehicle state information based on sensing data. The vehicle state information may be information generated based on data sensed by various sensors provided in the vehicle.

For example, the vehicle state information may include vehicle orientation information, vehicle speed information, vehicle tilt information, vehicle weight information, vehicle direction information, vehicle battery information, vehicle fuel information, information about the air pressure of tires of the vehicle, vehicle steering information, in-vehicle temperature information, in-vehicle humidity information, pedal position information, and vehicle engine temperature information.

Meanwhile, the sensing unit may further include a tension sensor. The tension sensor may generate a sensing signal based on the tension state of the safety belt.

The position data production device 280 may generate position data of the vehicle 10. The position data production device 280 may include at least one of a global positioning system (GPS) or a differential global positioning system (DGPS). The position data production device 280 may generate position data of the vehicle 10 based on a signal generated by at least one of the GPS or the DGPS. In some embodiments, the position data production device 280 may correct position data based on at least one of an inertia measurement unit (IMU) of the sensing unit 270 or the camera of the object detection device 210.

The position data production device 280 may be referred to as a positioning device. The position data production device 280 may be referred to as a global navigation satellite system (GNSS).

The vehicle 10 may include an internal communication system 50. A plurality of electronic devices included in the vehicle 10 may exchange a signal with each other via the internal communication system 50. The signal may include data. The internal communication system 50 may use at least one communication protocol (e.g. CAN, LIN, FlexRay, MOST, or Ethernet).

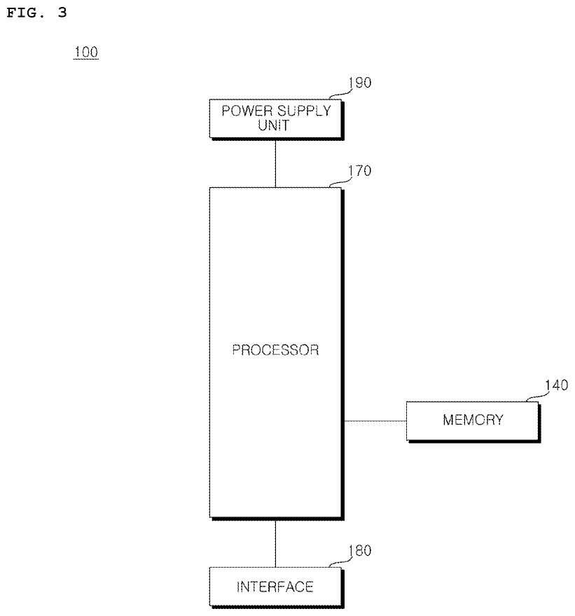

FIG. 3 is a control block diagram of an electronic device according to an embodiment of the present disclosure.

Referring to FIG. 3, the electronic device 100 may include a memory 140, a processor 170, an interface 180, and a power supply unit 190.

The memory 140 is electrically connected to the processor 170. The memory 140 may store basic data about the units, control data necessary to control the operation of the units, and data that are input and output. The memory 140 may store data processed by the processor 170. In a hardware aspect, the memory 140 may be constituted by at least one of a ROM, a RAM, an EPROM, a flash drive, or a hard drive. The memory 140 may store various data necessary to perform the overall operation of the electronic device 100, such as a program for processing or control of the processor 170. The memory 140 may be integrated into the processor 170. In some embodiments, the memory 140 may be classified as a low-level component of the processor 170.

The interface 180 may exchange a signal with the at least one electronic device provided in the vehicle 10 in a wired or wireless fashion. The interface 180 may exchange a signal with at least one of the user interface device 200, the object detection device 210, the communication device 220, the driving manipulation device 230, the main ECU 240, the vehicle driving device 250, the ADAS 260, the sensing unit 270, or the position data production device 280 in a wired or wireless fashion. The interface 180 may be constituted by at least one of a communication module, a terminal, a pin, a cable, a port, a circuit, an element, or a device.

The interface 180 may receive information about a traveling environment on a traveling road. The interface 180 may receive position data of the vehicle 10 from the position data production device 280. The interface 180 may receive traveling speed data from the sensing unit 270. The interface 180 may receive data about an object around the vehicle from the object detection device 210.

The power supply unit 190 may supply power to the electronic device 100. The power supply unit 190 may receive power from a power source (e.g. a battery) included in the vehicle 10, and may supply the received power to the respective units of the electronic device 100. The power supply unit 190 may be operated according to a control signal provided from the main ECU 240. For example, the power supply unit 190 may be realized as a switched-mode power supply (SMPS).

The processor 170 may be electrically connected to the memory 140, the interface 180, and the power supply unit 190 in order to exchange a signal therewith. The processor 170 may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

The processor 170 may be driven by power provided by the power supply unit 190. In the state of receiving power provided by the power supply unit 190, the processor 170 may receive data, may process the data, may generate a signal, and may provide the signal.

The processor 170 may receive information from another electronic device in the vehicle 10 through the interface 180. The processor 170 may receive information about traveling environment on the traveling road from the object detection device 210 and the position data production device 280 through the interface 180. The processor 170 may provide a control signal to another electronic device in the vehicle 10 through the interface 180.

The traveling environment information may include object information including the kind, number, and height of objects located in the traveling direction acquired by the object detection device 210 and GPS information acquired by the position data production device 280. The traveling environment information may include information about a road on which the vehicle is traveling and information about an obstacle around the vehicle.

The processor 170 may receive user input through the user interface device. For example, the processor 170 may receive at least one of voice input, gesture input, touch input, or mechanical input through the user interface device 200.

The electronic device 100 may include at least one printed circuit board (PCB). The memory 140, the interface 180, the power supply unit 190, and the processor 170 may be electrically connected to the printed circuit board.

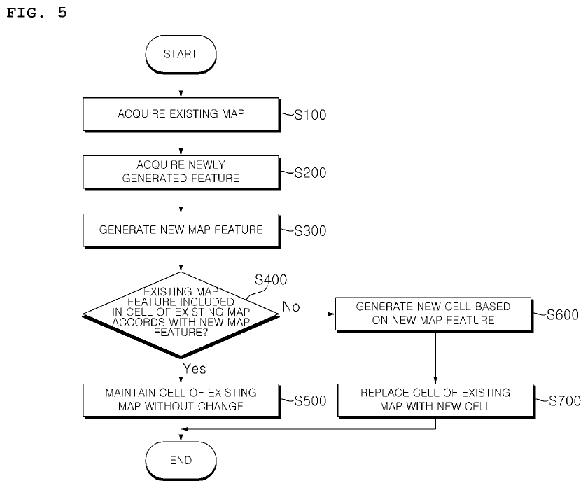

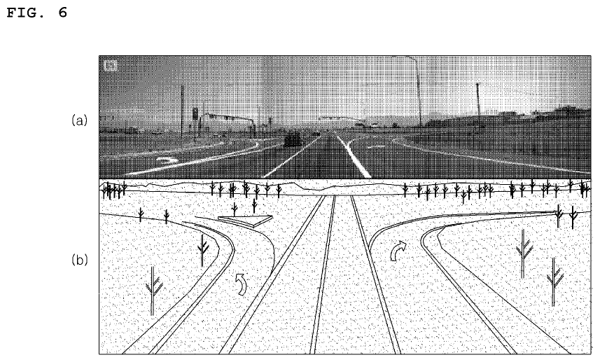

FIG. 5 is a flowchart of a processor according to an embodiment of the present disclosure. FIG. 6 shows an example in which a map feature according to an embodiment of the present disclosure is generated.

Referring to FIG. 5, the electronic device 100 includes a processor 170 for acquiring an existing map. Here, the existing map means a map that indicates a route along which the vehicle 10 travels and that has already been generated and is utilizable, and may be output through the user interface device 200 or the display unit of the vehicle 10. The processor 170 may determine whether to output the existing map through the user interface device 200 or the display unit without being changed or to output a new map replacing the existing map through at least a portion thereof, as will be described below.

The processor 170 may acquire the existing map through the interface 180. In this case, the interface 180 may acquire the existing map from at least one electronic device provided in the vehicle 10 for storing the existing map, or may acquire the existing map from an external server through the communication device 220, which is connected to the interface 180.

The processor 170 acquires a newly generated feature. Here, the feature means information that constitutes a map and information that is directly related to traveling of the vehicle 10. In an example, the feature may include a road, a lane, a guardrail, a speed bump, and a speed limit sign. In some embodiments, objects as a narrow meaning may also be displayed on the map, in addition to the feature. In an example, the objects as the narrow meaning may include another vehicle, a two-wheeled vehicle, a pedestrian, an animal, and a geographical body.

The processor 170 may acquire a newly generated feature through the interface 180. In this case, the processor 170 may acquire information classified as the feature, among objects as a wide meaning detected by the object detection device 210, through the interface 180. Here, the objects as the wide meaning are a concept including a feature and objects as a narrow meaning. In an example, the feature may be collected through the lidar provided in the object detection device 210. However, the feature collection device is not limited thereto.

The processor 170 may input the feature acquired through the interface 180 to an artificial neural network pre-trained through machine learning in order to generate a new map feature. That is, the processor 170 may generate a map feature that is utilizable as map information (e.g. FIG. 6(b)) from a feature acquired through the interface 180 using artificial intelligence technology (e.g. FIG. 6(a)).

Machine learning for artificial intelligence technology may be performed through supervised learning, in which, when information is input, the attributes of the information are also input, or unsupervised learning, in which only information is input without input of the attributes of the information. In an example, supervised learning, in which input information is taught to be a 25 MPH speed limit sign, may be performed, or unsupervised learning, in which the map information compares a feature that is newly generated while the vehicle travels in a correct area with a map feature stored in the existing map to recognize that the feature is a 25 MPH speed limit sign for itself, may be performed. When the machine learning is finished, therefore, the processor 170 may generate a new map feature that is utilizable as map information from the feature acquired through the interface 180.

Upon determining that an existing map feature included in a cell of the existing map discords with the new map feature, the processor 170 generates a new cell based on the new map feature. Here, the cell is a unit that partitions the map according to a level corresponding to the scale of the map, and is also called a parcel.

In the case in which the existing map feature corresponding to the new map feature is absent, the new map feature corresponding to the existing map feature is absent, or the attributes of the new map feature and the attributes of the existing map feature corresponding thereto are different from each other (e.g. in the case in which the speeds marked on the speed limit signs are different from each other or in the case in which the numbers of lanes on roads are different from each other), the processor 170 may determine that the existing map feature discords with the new map feature.

When the vehicle enters a cell in which discordance occurs, the processor 170 replaces the cell in which discordance occurs with a new cell. That is, when the vehicle 10 passes through a cell of the existing map in which the new map feature discords with the existing map feature, the processor 170 may generate a new cell, and, when the vehicle 10 enters a cell in which discordance occurs again, may replace the cell of the existing map with the new cell such that correct map information is output to the user interface device 200 or the display unit of the vehicle 10.

Meanwhile, when the vehicle 10, as an autonomous vehicle, passes through a cell in which discordance occurs for the first time, which means that a new cell is not yet present, the processor 170 may perform control such that autonomous traveling is continued based on sensing information acquired from the object detection device 210 through the interface 180.

Referring to FIG. 5, an operation method of the electronic device 100 includes a step of at least one processor 170 acquiring an existing map (S100), a step of the at least one processor 170 acquiring a newly generated feature (S200), and a step of the at least one processor 170 inputting the feature to an artificial neural network pre-trained through machine learning in order to generate a new map feature (S300).

The operation method of the electronic device 100 includes a step of the at least one processor 170 determining whether an existing map feature included in a cell of the existing map accords with the new map feature (S400) after the step of generating the new map feature (S300).

The operation method of the electronic device 100 includes a step of the at least one processor 170 maintaining the cell of the existing map as map information without being changed (S500) upon determining at the determination step (S400) that the existing map feature accords with the new map feature.

The operation method of the electronic device 100 includes a step of the at least one processor 170 generating a new cell based on the new map feature (S600) upon determining at the determination step (S400) that the existing map feature discords with the new map feature.

Meanwhile, the operation method of the electronic device 100 may include a step of the at least one processor 170 issuing a control signal such that autonomous traveling is performed based on sensing information acquired from the object detection device 210 through the interface 180 when the vehicle 10, as an autonomous vehicle, passes through a cell in which discordance occurs for the first time, which means that a new cell is not yet present, upon determining at the determination step (S400) that the existing map feature discords with the new map feature.

The operation method of the electronic device 100 includes a step of the at least one processor 170 replacing a cell in which discordance occurs with the new cell when the vehicle enters the cell in which discordance occurs (S700) after the new cell generation step (S600).

The operation method of the electronic device 100 includes a step of performing control such that the cell of the existing map or the new cell is output to the user interface device 200 or the display unit of the vehicle 10 as map information after the maintenance step (S500) or the replacement step (S700).

That is, a new cell is generated when the vehicle 10 passes through a cell in which discordance occurs, and the new cell is loaded as map information when the vehicle 10 passes through a cell in which discordance occurs again. Even in the case in which existing map information is absent or incorrect, therefore, a correct map that is newly generated may be displayed, which is advantageous in terms of traveling convenience and traveling safety.

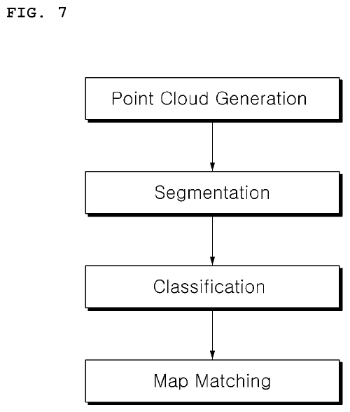

FIG. 7 shows an example of a process of generating a cell from a feature according to an embodiment of the present disclosure.

Referring to FIG. 7, the processor 170 may generate a new cell through four steps. That is, a first step may be a step of detecting an object as a wide meaning around the vehicle 10 through a sensor device, such as a lidar, provided in the object detection device 210, and may be a point cloud generation step, at which an object as a wide meaning is generated in the form of a point cloud.

Subsequently, a second step may be a segmentation step, at which the point cloud is internally segmented by object in consideration of connectivity between points of the point cloud. At the segmentation step, a feature may be displayed in the state of being separated from an object as a narrow meaning. The point cloud generation step and the segmentation step may be performed by the object detection device 210. In this case, information about the feature may be provided to the processor 170 through the interface 180.

Subsequently, a third step may be a classification step, at which the attributes of the feature (e.g. a lane, a road, and a speed limit sign) are classified using artificial intelligence technology or deep learning technology. The feature acquired from the object detection device 210 after the above three steps may be generated as a new map feature. Finally, a fourth step may be a map matching step of determining whether the new map feature accords with an existing map feature included in a cell of the existing map and, upon determining that the new map feature discords with the existing map feature, generating a new cell based on the new map feature.

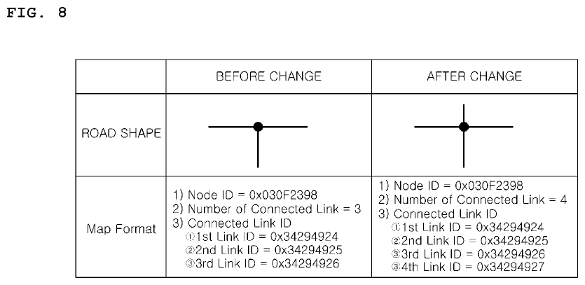

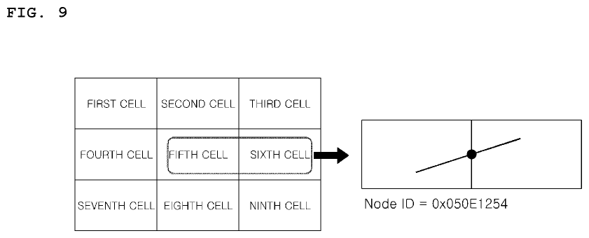

FIGS. 8 and 9 illustrate an example of the format of an existing map according to an embodiment of the present disclosure.

In the case in which an existing map feature discords with a new map feature and thus a new cell including the new map feature is generated, the processor 170 may generate the new cell so as to be compatible with the format of an existing map.

Referring to FIG. 8, in the case in which an existing map feature is at least two roads that are connected to each other, the format of an existing map may be designed such that a crossing node is generated at the connection between the at least two roads. This format of the existing map is designed in consideration of extensibility of roads. Before the roads are changed, three roads having Link IDs of 0x34294924, 0x34294925, and 0x342949246 are connected to a crossing node having a node ID of 0x030F2398. Even when a road having a Link ID of 0x34294927 is added according to the change of the roads, the added road may be connected to the crossing node, whereby the added road may be easily incorporated into the existing format.

Referring to FIG. 9, in the case in which an existing map feature is located in at least two cells, the format of an existing map may be designed such that a connection node is generated at a point at which the existing map feature is located at the boundary between the at least two cells. This format of the existing map is designed to accurately display the position of the existing map feature in a plurality of cells. A connection node having a node ID of 0x050E1254 may include information indicating that the existing map feature is connected from a fifth cell to a sixth cell.

That is, a new cell is generated so as to be compatible with the format of an existing map, whereby interlocking with the existing map is secured. In addition, even when a new map feature, such as road information, is changed after the new cell is generated, it is possible to easily update the new cell, which is advantageous.

Referring to FIGS. 8 and 9, the new cell generation step (S600) of the operation method of the electronic device 100 may include a step of the at least one processor including a new map feature and generating a new cell so as to be compatible with the format of the existing map.

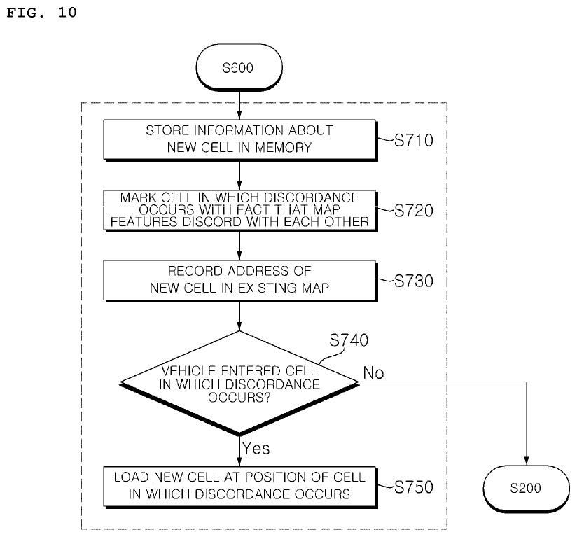

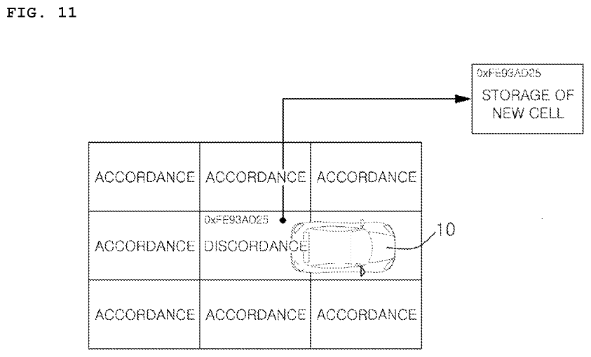

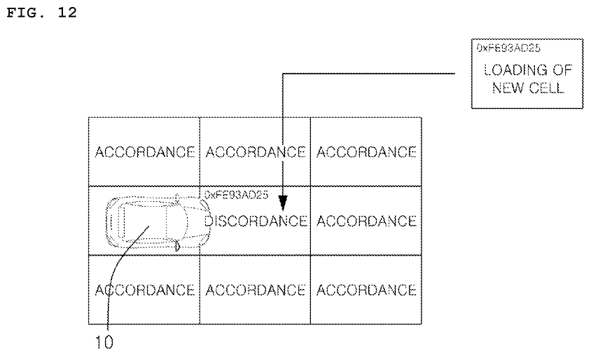

FIG. 10 is a view showing an embodiment of a replacement step (S700) according to an embodiment of the present disclosure. FIGS. 11 and 12 show an example of storage and loading of a new cell according to an embodiment of the present disclosure.

Referring to FIG. 10, the electronic device 100 may further include a memory 140, and the memory 140 may receive and store information about a new cell from the processor 170. Meanwhile, in some embodiments, information about a new cell generated by the processor 170 may be transmitted to at least one electronic device provided in the vehicle through the interface 180 so as to be stored therein, or may be transmitted to an external server through the communication device 220 so as to be stored therein.

The processor 170 may record the address of the new cell, stored in the memory, in an existing map. Consequently, the processor 170 may load the new cell through the address of the new cell.

Upon determining that an existing map feature included in a cell of an existing map discords with a new map feature, the processor 170 may mark the cell in which discordance occurs with the fact that discordance occurs. In an example, the address of the new cell may be recorded in the cell in which discordance occurs in order to mark the cell in which discordance occurs with the fact that discordance occurs. However, the marking method is not limited thereto. Consequently, the driver or the autonomous vehicle may recognize that the vehicle 10 enters the cell in which discordance occurs.

Referring to FIG. 11, when the vehicle 10 passes through the cell in which discordance occurs, a new cell is generated. The generated new cell is stored in the memory while having an address of 0xFE93AD25, and the address of the new cell is recorded in the cell in which discordance occurs, whereby the cell in which discordance occurs may be marked with the fact that discordance occurs.

In the case in which the vehicle 10 enters the cell in which discordance occurs, the processor 170 may load information about the new cell stored in the memory 140 based on the address of the new cell previously generated in response thereto at the position of the cell in which discordance occurs. That is, the processor 170 may replace the cell in which discordance occurs with the new cell such that correct map information is output to the user interface device 200 or the display unit of the vehicle 10.

Referring to FIG. 12, when the vehicle 10 is adjacent to the cell in which discordance occurs, storage of a new cell that will replace the cell in which discordance occurs may be recognized from the fact that the cell in which discordance occurs is marked, and the new cell having the address of the new cell recorded in the existing map, i.e. an address of 0xFE93AD25, may be loaded in order to replace the cell in which discordance occurs.

That is, a new cell is generated when the vehicle 10 passes through a cell in which discordance occurs, and the new cell is loaded as map information when the vehicle 10 passes through a cell in which discordance occurs again. Even in the case in which existing map information is absent or incorrect, therefore, a correct map that is newly generated may be displayed, which is advantageous in terms of traveling convenience and traveling safety.

Referring to FIGS. 10 to 12, the replacement step (S700) of the operation method of the electronic device 100 may include a step of the at least one processor 170 transmitting information about the new cell to the memory 140 such that the information about the new cell is stored in the memory 140 (S710).

The replacement step (S700) may include a step of the at least one processor 170 marking the cell in which discordance occurs with the fact that discordance occurs (S720) after the transmission step (S710).

The replacement step (S700) may include a step of the at least one processor 170 recording the address of the new cell, stored in the memory 140, in the existing map (S730) after the marking step (S720).

In some embodiments, however, the marking step (S720) and the recording step (S730) may be performed in reverse order or simultaneously. Particularly, in the case in which the marking step (S720) and the recording step (S730) are simultaneously performed, the address of the new cell may be recorded in the cell in which discordance occurs, whereby the cell in which discordance occurs may be marked with the fact that discordance occurs.

The replacement step (S700) may include a step of the at least one processor 170 loading the information about the new cell stored in the memory 140 based on the address of the new cell at the position of the cell in which discordance occurs when the vehicle 10 enters the cell in which discordance occurs (S750) after the recording step (S730). That is, according to the loading step (S750), control may be performed such that the new cell is output to the user interface device 200 or the display unit of the vehicle 10 as map information.

Meanwhile, in some embodiments, the operation method of the electronic device 100 may include a step of the at least one processor 170 informing the user that the new map information is output instead of the existing map information after the loading step (S750). Consequently, the user of the vehicle 10 may easily recognize necessity to update the existing map information.

The present disclosure as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disc, and an optical data storage device. In addition, the computer-readable medium may be implemented as a carrier wave (e.g. data transmission over the Internet). In addition, the computer may include a processor or a controller. Thus, the above detailed description should not be construed as being limited to the embodiments set forth herein in all terms, but should be considered by way of example. The scope of the present disclosure should be determined by the reasonable interpretation of the accompanying claims and all changes in the equivalent range of the present disclosure are intended to be included in the scope of the present disclosure.

1. An electronic device for vehicles, the electronic device comprising:
an interface; and
a processor configured:
to acquire an existing map through the interface;
to acquire a newly generated feature through the interface;
to input the feature to an artificial neural network pre-trained through machine learning in order to generate a new map feature;
to generate a new cell based on the new map feature upon determining that an existing map feature included in a cell of the existing map discords with the new map feature; and
to replace the cell in which discordance occurs with the new cell when a vehicle enters the cell in which discordance occurs.

2. The electronic device according to claim 1, wherein the processor generates the new cell so as to include the new map feature and to be compatible with a format of the existing map.

3. The electronic device according to claim 2, wherein, in a case in which the existing map feature is located in at least two cells, the format of the existing map is designed such that a connection node is generated at a point at which the existing map feature is located at a boundary between the at least two cells.

4. The electronic device according to claim 2, wherein, in a case in which the existing map feature is at least two roads that are connected to each other, the format of the existing map is designed such that a crossing node is generated at a connection between the at least two roads.

5. The electronic device according to claim 1, further comprising:
a memory, wherein
the memory is configured to receive and store information about the new cell from the processor.

6. The electronic device according to claim 5, wherein the processor is configured to mark the cell in which discordance occurs with a fact that discordance occurs.

7. The electronic device according to claim 6, wherein the processor is configured to record an address of the new cell, stored in the memory, in the existing map.

8. The electronic device according to claim 7, wherein, when the vehicle enters the cell in which discordance occurs, the processor loads information about the new cell stored in the memory based on the address of the new cell at a position of the cell in which discordance occurs.

9. An operation method of an electronic device for vehicles, the operation method comprising:
at least one processor acquiring an existing map;
the at least one processor acquiring a newly generated feature;
the at least one processor inputting the feature to an artificial neural network pre-trained through machine learning in order to generate a new map feature;
the at least one processor generating a new cell based on the new map feature upon determining that an existing map feature included in a cell of the existing map discords with the new map feature; and
the at least one processor replacing the cell in which discordance occurs with the new cell when a vehicle enters the cell in which discordance occurs.

10. The operation method according to claim 9, wherein the step of generating the new cell comprises the at least one processor generating the new cell so as to include the new map feature and to be compatible with a format of the existing map.

11. The operation method according to claim 9, wherein the replacing step comprises the at least one processor transmitting information about the new cell to the memory such that the information about the new cell is stored in the memory.

12. The operation method according to claim 11, wherein the replacing step comprises the at least one processor marking the cell in which discordance occurs with a fact that discordance occurs.

13. The operation method according to claim 12, wherein the replacing step comprises the at least one processor recording an address of the new cell, stored in the memory, in the existing map.

14. The operation method according to claim 13, wherein the replacing step comprises the at least one processor loading the information about the new cell stored in the memory based on the address of the new cell at a position of the cell in which discordance occurs when the vehicle enters the cell in which discordance occurs.
